(19) United States
(12) Patent Application Publication
(10) Pub. No.: US 2015/0305068 A1
(43) Pub. Date: Oct. 22, 2015

(54) METHOD AND DEVICE FOR COMMUNICATION BACK END PROCESSING BASED ON DYNAMIC FEEDBACK OF USER END TO CONFIGURE COMMUNICATION LINKING

(71) Applicant: Yuan Ze University, Tao-Yuan County (TW)

(72) Inventors: Heng-Tung Hsu, Tao-Yuan County (TW); Tso-Jung Chang, Tao-Yuan County (TW)

(73) Assignee: Yuan Ze University, Tao-Yuan County (TW)

(21) Appl. No.: 14/255,152

(22) Filed: Apr. 17, 2014

(51) Int. Cl. H04W 76/02; H04W 8/22

(52) U.S. Cl. CPC H04W 76/02; H04W 8/22; H04W 88/08

(57) ABSTRACT

In a device and a method for communication back end processing based on user end dynamic feedback to configure communication linking, the communication back end processing device includes a communication module and an optimization configuration module. The communication module communicates with a plurality of external base stations, one of base stations communicates with an external user end. The optimization configuration module is electrically connected to the communication module and triggers the user end to transmit user information to the optimization configuration module. The optimization configuration module triggers the base station to transmit the base station information to the optimization configuration module. The optimization configuration module according to user information and at least one piece of base station information assigns a base station to connect the user end, so as to optimize the communication linking status between assigned base station and user end.

### BACKGROUND OF THE INVENTION

1. Field of the Invention

The present invention is related to a communication back end processing device and method thereof. More particularly, the present invention is related to a method and device for communication back end processing based on dynamic feedback of user end to configure communication linking.

2. Description of the Prior Art

Conventional base station is usually built in static configuration. This kind of configuration is unable to adjust radiation direction of individual base station, thus beams of adjacent base stations are usually overlapped and influenced as shown in FIG. 1. When the user end is in overlapping area (A01), it is influenced by signals of two base stations and communication quality is reduced. To solve this issue, conventional technologies apply different operation frequencies in adjacent base stations and the user end can check and verify the different signals. However, this solution will dramatically compress available wireless bandwidth, and Up Linking (UL) speed and Down Linking (DL) speed of user would be seriously influenced.

Another conventional solution is to provide multi-beam smart antenna to deal with overlapping interference. Smart antenna is configured to change beam direction by electrical or mechanical method, and thus the communication service coverage area can be adjusted. However, the conventional base station does not provide joint configuration for cooperation with other base stations.

Conventional technologies also apply Heterogeneous Network to solve aforementioned issues. Heterogeneous Network is configured to provide different communication protocols to different communication devices in the same communication service area to reduce frequency interference and distribute proper bandwidth to user end. However this technology does not mention how to retrieve information for later distribution, and how to properly arrange service based on the information.

Conventional technologies also apply algorithms to calculate base stations configuration. However, disclosed configuration of conventional technologies is not able to dynamically adjusting in response to communication environment, user's location, and user's habit to meet instant communication and environment demand of user.

The aforementioned technologies only disclose service configuration of a single base station, and do not disclose joint configuration of base station group in an area. Thus, providing a communication back end processing device and method thereof to configure communication linking by analyzing base station communication demand of the area is a technical issue needed to be solved in the technical field.

### SUMMARY OF THE INVENTION

To solve the aforementioned technical issue of conventional technologies, one objective of the invention is to provide a communication back end processing device and method thereof based on dynamic feedback of user end to configure communication linking to solve service configuration issue of base station.

To achieve the aforementioned objective, the present invention provides a device for communication back end processing based on dynamic feedback of user end to configure communication linking. The communication back end processing device comprises a communication module and an optimization configuration module. The communication module is communicated with a plurality of external base stations, one of base stations communicating with at least one external user end, wherein the user end is a mobile communication device.

The optimization configuration module receives a piece of user information from the user end through the communicated base station. The user end is trigged by the optimization configuration module to send the user information or send the user information activity. The optimization configuration module receives base station information from each of base stations. The base station is trigged by the optimization configuration module to send the base station information or send the base station information activity.

To achieve the aforementioned objective, the present invention provides a method for communication back end processing based on user end dynamic feedback to configure communication linking. The method is applied in a communication back end processing device. The method comprises steps as below.

First, the communication back end processing device communicates with a plurality of external base stations. One of base stations communicates with an external user end and the user end is a mobile communication device. Then, the communication back end process device receives a piece of user information from the user end. The piece of user information records communication status of the user end. Furthermore, the communication back end processing device receives a piece of base station information from each of the base stations. The piece of base station information records communication status of each base station. Final, the communication back end processing device executes an optimization configuration according to a piece of user information or at least one base station information. The optimization configuration optimizes a communication linking status between the assigned base station and the user end.

As aforementioned description, the communication back end processing device and method thereof of the present invention are based on dynamic feedback status information of user end or base station to optimize the communication linking for providing optimized communication service to the user end.

### BRIEF DESCRIPTION OF THE DRAWINGS

FIG. 1 shows communication service area overlapping issue of conventional technologies;

FIG. 2A shows the operation environment of the communication back end processing device of the present invention;

FIG. 2B shows a block diagram of the communication back end processing device of the present invention;

FIG. 3 shows a flow chart of the communication back end processing method of the present invention;

FIG. 4 shows a flow chart of dynamic feedback among the user end and the base station of the communication back end processing method of the present invention;

FIG. 5 shows a flow chart of the first embodiment of the present invention;

FIGS. 6A-6B show operation of the first embodiment of the present invention; and

FIG. 7 shows operation of the second embodiment of the present invention.

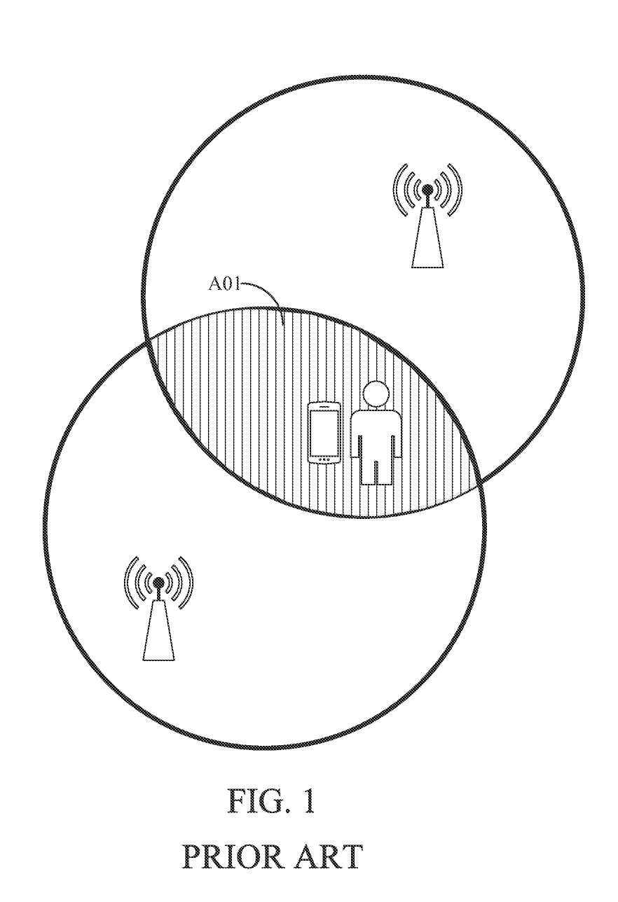

### DETAILED DESCRIPTION OF THE PREFERRED EMBODIMENT

The following description provides several embodiments for explaining the present invention. However, it is not intended to limit the scope of the present invention.

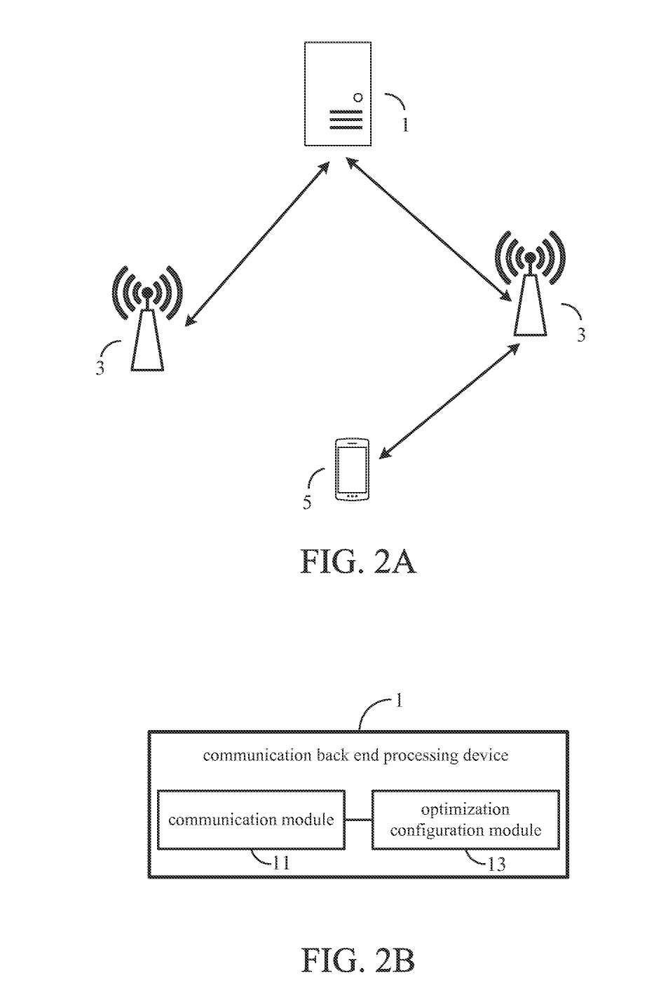

FIG. 2A shows operation environment of the communication back end processing device of the present invention. Also referring to FIG. 2B, the communication back end processing device 1 comprises a communication module 11 and an optimization configuration module 13.

The communication module 11 is communicated with a plurality of external base stations 3 by wireline or wireless. And one of base stations 3 is communicating with an external user end 5 by wireless. The user end 5 is a mobile communication device, such as a mobile phone, mobile tablet, etc.

The optimization configuration module 13 is electrically connected to communication module 11. The optimization configuration module 13 further triggers the user end 5 to send a piece of user information to the optimization configuration module 13 through the base station 3, or receives the piece of user information sent by the user end activity. Aforementioned the piece of user information records the communication status of user end 5. The optimization configuration module 13 further triggers each base station 3 to transmit a piece of base station information or receives the base station information sent by base station activity. The base station information records communication status of each base station 3. The optimization configuration module 13 further processes optimization configuration according to the user information or at least one piece of base station information. The optimization configuration assigns one of the base stations 3 to connect the user end to optimize the communication linking status.

The optimization configuration module 13 further uses a greedy algorithm, an ant colony algorithm, a simulated anneal algorithm, or a genetic algorithm to perform the optimization configuration. And the optimization configuration module 13 is further configured to select greedy algorithm to calculate the optimized configuration result matching user information of the multi-user end situation. Also, the moving velocity of the user end 5 is taken as a vector parameter in combined dynamic programming algorithm for optimized configuration.

The aforementioned user information comprises a geographic information, a receive signal strength, RSS, a channel quality information, CQI, a data transmission speed information, and a registered cell ID. The geographic information records the geographic location of the user end 5, which can be a global position system information or relative geographic information between the user end 5 and the base station 3. And the RSS records the signal strength received by the user end 5 and send from the communicated base station 3. The CQI records communication quality between the user end 5 and the communicated base station 3.

The data transmission speed information records the data transmission speed between the user end 5 and the communicated base station 3.

The linked base station number information records the number of base station 3 communicated with the user end 5.

The aforementioned base station information further comprises a piece of identity number information, a piece of service type information, a piece of geometrical location information, or a piece of operation status information. The piece of identity number information records number of the base station 3.

The piece of service type information records a protocol of communication service provided by the base station 3, such as 2G, 3G, Wi-Fi, and etc. The piece of geometrical location information records geometrical location of the base station 3. The piece of operation status information records operation schedule busy status of the base station 3.

Each of base station 3 further comprises a beam-forming antenna. The present invention applies phase shifting array antenna method or mechanical rotation method to control the beam direction of beam-forming antenna.

The optimization configuration further enables the base station 3 to adjust the radiating feature of the radiating beam to optimize the communication linking status. The radiating feature comprises radiating direction, beam width, beam number, or beam radiant intensity. Aforementioned optimization configuration is building communication linking between the assigned base station 3 and user end 5 to optimize the communication linking status.

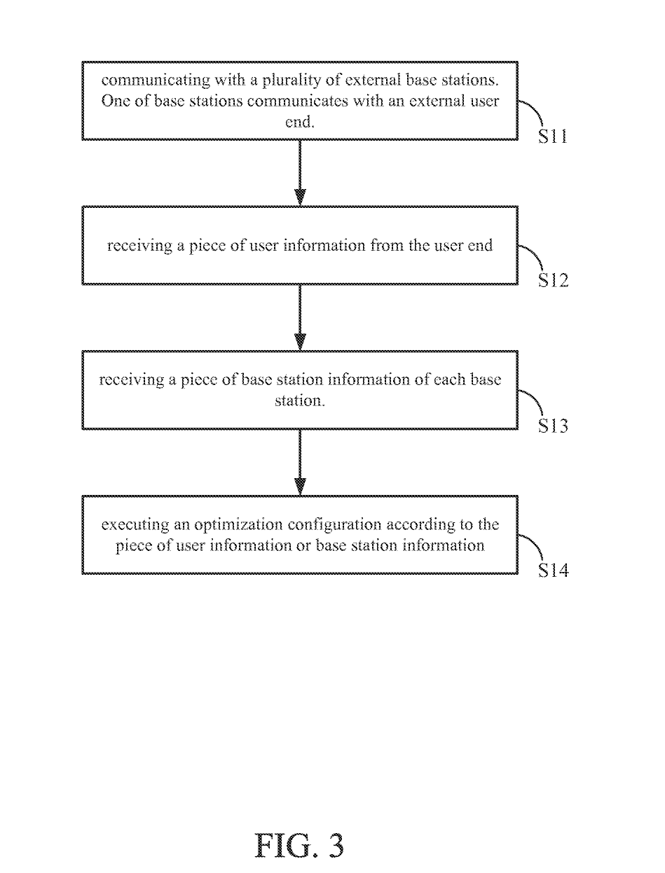

FIG. 3 shows a method for communication back end processing based on dynamic feedback of user end to optimize communication configuration. The method is applied in a communication back end processing device. The method comprises steps as below.

S11: communicating with a plurality of external base stations. One of base stations communicates with an external user end. And the user end is a mobile communication device.

S12: receiving a piece of user information from the user end via the communicated base station. The piece of user information records communication status of the user end.

S13: receiving a piece of base station information of each base station. The piece of base station information records communication status of each base station.

S14: executing an optimization configuration. The optimization configuration assigns one of the base stations and configures a communication linking status between the assigned base station and the user end according to the piece of user information or base station information.

The aforementioned user information comprises a geographic information, a receive signal strength, RSS, a channel quality information, CQI, a data transmission speed information, and a linked base station number information. The geographic information records the geographic location of the user end. The RSS records the signal strength the user end received from the communicated base station. The CQI records communication quality between the user end and the communicated base station. The data transmission speed information records the data transmission speed between the user end and the communicated base station. The linked base station number information records the number of base station communicated with the user end.

The aforementioned base station information further comprises a piece of identity number information, a piece of service type information, a piece of geometrical location information, or a piece of operation status information. The piece of identity number information records number of the base station. The piece of service type information records a protocol of communication service provided by the base station. The piece of geometrical location information records geometrical location of the base station. The piece of operation status information records operation schedule busy status of the base station.

The base station further comprises a beam-forming antenna. The optimization configuration further enables the base station to adjust the radiating feature of the radiating beam to optimize the communication linking status. The radiating beam is outputted by the beam-forming antenna. And the radiating feature comprises radiating direction, beam width, beam number and beam radiant intensity. The optimization configuration enables the assigned base station to build communication linking to optimize the communication linking status.

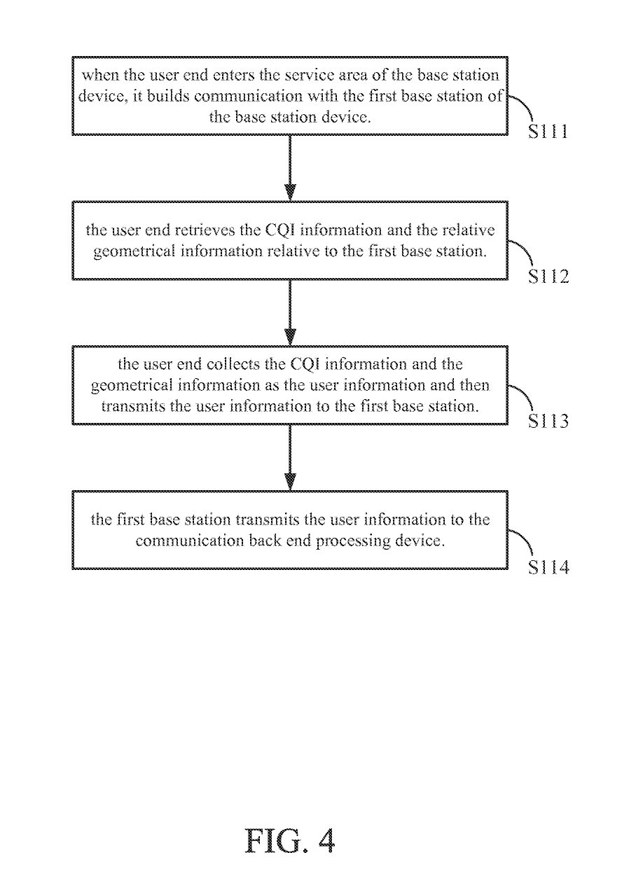

FIG. 4 shows further steps of Step S11 as below.

S111: when the user end enters the service area of the base station device, it builds communication with the first base station of the base station device.

S112: the user end retrieves the CQI information and the relative geometrical information relative to the first base station.

S113: the user end collects the CQI information and the geometrical information as the user information and then transmits the user information to the first base station. The transmission of user information is done by the communication back end processing device continuously triggering the user end to transmit the user information. Or the transmission of user information is done by the user end instantly updating the user information and transmitting the user information once it is updated.

S114: the first base station transmits the user information to the communication back end processing device.

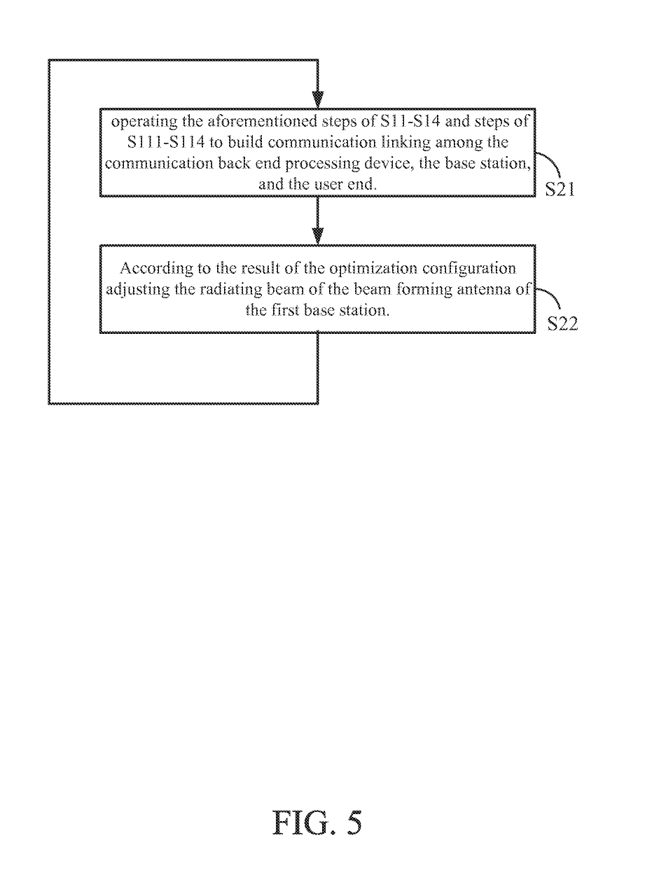

FIG. 5 shows the first embodiment of the present invention. The first embodiment cyclically operates the steps as below.

S21: operating the aforementioned steps of S11-S14 and steps of S111-S114 to build communication linking among the communication back end processing device 1, the base station 3, and the user end 5.

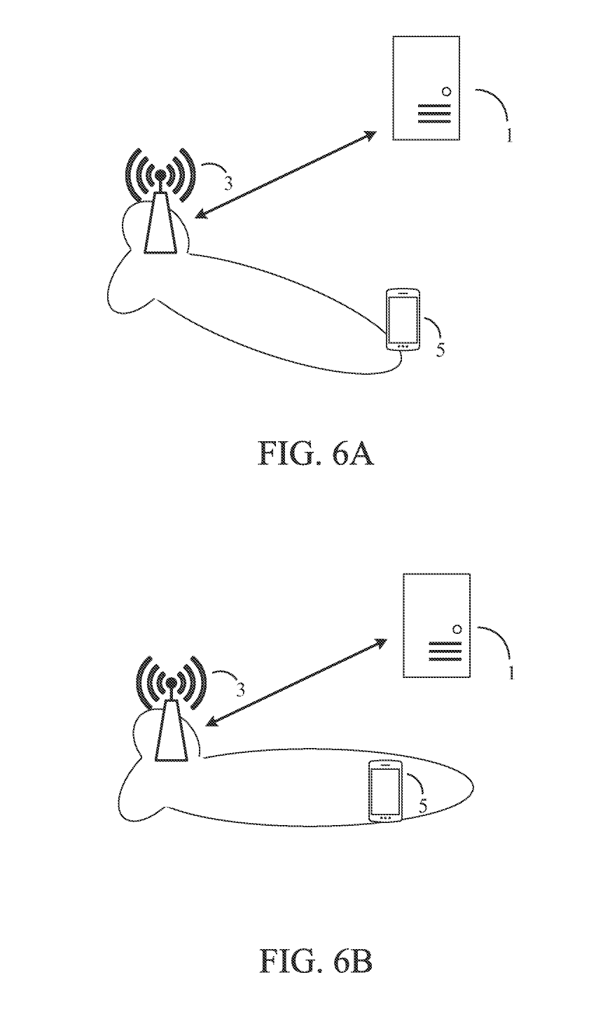

S22: according to the result of optimization configuration adjusting the radiating direction of the radiating beam of the beam-forming antenna of the first base station 31 to the direction of user end 5, adjusting the beam width to provide the user end 5 more complete covering area of communication service, adjusting the beam number to enhance the communication channel between the user end 5 or suppress other interference signal source. FIG. 6A shows first example that when the optimization configuration module analyzes the radiating beam of the first base station 31 and determines that the radiating beam does not completely cover the user end 5. Then, jointly refer to FIG. 6B showing that the optimization configuration module 13 enables the first base station 31 to adjust its beam direction or enlarge its beam width to completely cover the user end 5 within the communication service area of the first base station 31. The second example shows that when the optimization configuration module 13 analyzes the receiving signal strength of the signal received by the user end 5 and determines that the receiving signal strength is weak, and the user end 5 is within the communication service area of the first base station 31, the optimization configuration module would enable the first base station 31 to enhance its radiant intensity of the radiating beam, so that the user end 5 can receive more clear signal.

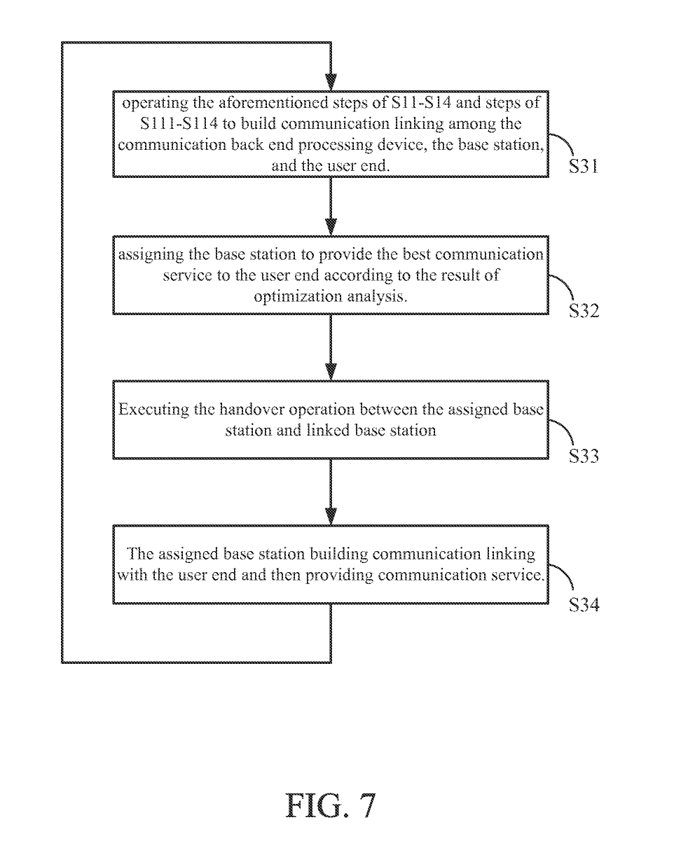

FIGS. 2A, 2B, and 7 jointly show the second embodiment of the present invention. The second embodiment of the present invention cyclically operates the steps as below.

S31: operating the aforementioned steps of S11-S14 and steps of S111-S114 to build communication linking among the communication back end processing device 1, the base station 3, and the user end 5, and to process optimization analysis. The base station 3 comprises the first base station 31 and the second base station 33.

S32: assigning the base station 3 to provide the best communication service to the user end 5 according to the result of optimization analysis, and assigning the base station 3 (first base station 31) originally communicated with the user end 5 and the assigned base station 3 (second base station 33) to execute handover operation.

S33: executing the handover operation between the assigned base station (second base station 33) and linked base station (first base station 31). Then the first base station 31 transferring the user information of the user end 5 to the second base station 33.

S34: the assigned base station (second base station 33) building communication linking with the user end 5 and then providing communication service.

For example, if the user end 5 is originally communicated with the first base station 31, and the optimization configuration module 13 analyzes and determines that the operation status information of first base station 31 is busy, meanwhile it shows that the second base station 33 is able to provide better communication service, the optimization configuration module 13 would assign the second base station 33 to provide communication service to the user end 5, and has the first base station 31 and the second base station 33 to execute handover operation. The optimization configuration module 13 would further check whether the user end 5 is within the overlapping area of radiating beam covering area of the first base station 31 and radiating beam covering area of the second base station 33. If the user end 5 is within the overlapping area, the optimization configuration module 13 would enables the unassigned base station 3 to adjust its radiating direction or beam width moving away from the communication service area of the assigned base station 3 to eliminate overlapping interference.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A device for communication back end processing based on user end dynamic feedback to configure communication linking, comprising:
a communication module, communicated with a plurality of external base stations, one of base stations communicating with an external user end, wherein the user end is a mobile communication device; and
an optimization configuration module, electrically connected to the communication module, the optimization configuration module receiving a piece of user information recorded communication status of the user end, the optimization configuration module receiving a plurality of pieces of base station information separately recorded communication status of each of the base station, wherein the optimization configuration module further processes an optimize configuration according to the piece of user information or at least one base station information, wherein the optimize configuration optimizes a communication linking status between the assigned base station and the user end.

2. The device according to claim 1, wherein the piece of user information further comprises:
a piece of geometrical information, recorded a geometrical location of the user end;
a piece of received signal strength indication (RSSI) information, recorded signal strength which is received by the user end and send by the communicated base station;
a piece of channel quality information, recorded communication quality between the user end and the base station;
a piece of data transmitting speed information, recorded data transmitting speed between the user end and the base station;
a piece of linked base station number information, recorded the number of the base stations which communicate with the user end.

3. The device according to claim 1, wherein each of the base station further comprises:
a piece of identity number information, recorded identity number of the base stations;
a piece of service type information, recorded a protocol of communication service provided by the base station;
a piece of geometrical location information, recorded a geometrical location of the base station; and
a piece of operation status information, recorded an operation schedule status of the base station.

4. The device according to claim 1, wherein each of the base stations further comprises a beam-forming antenna, the optimization configuration trigging the base station to adjust a radiating feature of a radiating beam to optimize the communication linking status, wherein the radiating beam is outputted by the beam-forming antenna, wherein the radiating feature comprises radiating direction, beam width, beam number and beam radiant intensity.

5. The device according to claim 1, wherein the optimization configuration builds communication linking between the assigned base station and the user end to optimize the communication linking status.

6. A communication back end processing method based on user end dynamic feedback, applied in a communication back end processing device, comprising the following steps:
communicating with a plurality of external base stations, one of base stations communicating with an external user end, wherein the user end is a mobile communication device;
receiving a piece of user information from the user end, the piece of user information recorded communication status of the user end;
receiving a piece of base station information from each of the base stations, the piece of base station information recording communication status of each of the base stations; and
executing an optimization configuration according to a piece of user information or at least one base station information, wherein the optimization configuration optimizes a communication linking status between the assigned base station and the user end.

7. The method according to claim 6, wherein the piece of user information further comprises:
a piece of geometrical information, recorded geometrical location of the user end;
a piece of receiving signal strength indication (RSSI) information, recorded signal strength which received by the user end and send by the communicated base station;
a piece of channel quality information, recorded communication quality between the user end and the communicated base station;
a piece of data transmitting speed information, recorded data transmitting speed between the user end and the base station; and
a piece of linked base station number information, recorded the number of the base stations which communicate with the user end.

8. The method according to claim 6, wherein each of the base stations further comprises:
a piece of identity number information, recorded number of the base stations;
a piece of service type information, recorded a protocol of communication service provided by the base station;
a piece of geometrical location information, recorded geometrical location of the base station; and
a piece of operation status information, recorded operation schedule status of the base station.

9. The method according to claim 6, wherein the base station further comprises a beam-forming antenna, the optimization configuration further enabling the base station to adjust a radiating feature of a radiating beam to optimize the communication linking status, wherein the radiating beam is outputted by the beam-forming antenna, wherein the radiating feature comprises radiating direction, beam width, beam number and radiant intensity.

10. The method according to claim 6, wherein the optimization configuration enables the assigned base station to build communication linking with the user end to optimize the communication linking status.
